(19) United States
(12) Patent Application Publication
(10) Pub. No.: US 2007/0195298 A1
(43) Pub. Date: Aug. 23, 2007

(54) Imaging system

(76) Inventors: Jonathan David Hares, Oxfordshire (GB); Paul Michael William French, London (GB); Christopher William Dunsby, Guildford (GB); Mark Andrew Neil, Oxford (GB)

Correspondence Address: NIXON & VANDERHYE, PC, 901 NORTH GLEBE ROAD, 11TH FLOOR, ARLINGTON, VA, 22203, US

(21) Appl. No.: 11/631,958

(22) PCT Filed: Jul. 8, 2005
(86) PCT No.: PCT/GB05/02692

§ 371 Date: Apr. 18, 2007

(30) Foreign Application Priority Data
Aug. 4, 2004 (GB) 0417381.1

(51) Int. Cl. G03B 27/42

(52) U.S. Cl. 355/53

(57) ABSTRACT

An imaging apparatus comprising: a capture device (4,5) operate e to capture a sequence of component images of a target (2) to be imaged; and an image generator (4,5) operable to generate a plurality of output images; wherein the image generator is operable to generate respective output images from corresponding subsets of two or more component images, and the capture device is operable to capture the component images such that the component images of one subset are interleaved with the component images of other subsets in the sequence of component images.

This invention relates to an imaging apparatus and method.

It is well known to use an image capture device to capture a set of images of a target (such as a biological sample) and then to compare and/or combine the captured images in order to deduce information about the target and/or improve the accuracy/reliability of the information deduced. The conditions for capturing the images may be varied from image to image, for example (i) by altering the exposure time of the capture device or (ii) by altering the delay time between illuminating the target and capturing the image or (iii) capturing images through different optical filters, e.g. to provide wavelength ratiometric imaging or to image polarisation anisotropy.

An example of such imaging occurs in fluorescence lifetime imaging (FLIM), in which a target is provided with fluorescent molecules that can be used to identify areas of the target that have certain characteristic lifetimes. Optical imaging techniques can then be used to produce maps of the fluorophore lifetime. An example FLIM arrangement involves the target being illuminated with a modulated light source, such as a high frequency repetitively pulsed laser. The resulting fluorescence signal is captured, for example by a repetitively triggered camera with an exposure time that is less than the period of the repetitive illumination. Different images are captured at different delay times following a pulse of illumination. The time dependence of the fluorescence signal relative to the illumination of the target is then analysed. Analysis of the time dependence of the fluorescence signal can provide enhanced contrast in the resulting image of the target. This technique is particularly useful, for example, in biological imaging.

Such time dependence analysis may be performed in the time or frequency domain. However, in general both schemes make use of a modulated light source and a modulated detector, and two or more images are captured while varying the timing between the illumination by the modulated light source and the capture by the modulated detector. The relationship between the timing of the illumination by the modulated light source and the capture by the modulated detector will be referred to as the “phase” of the source and the detector.

In many applications, it is desirable to capture a set of images, for example four, with different phases and exposure times. It is preferable to do this as quickly as possible in order to reduce the possibility of and effects of motion blurring (for example if the target is not stationary). This is important as the relative displacements of the sequential images with respect to each other may result in pixels of subsequent frames not corresponding to the same area on the target, which may cause problems with the subsequent analysis. In other applications sample bleaching or changes in the power of the illumination signal, on a timescale comparable to the image acquisition time, can also lead to errors in the subsequent analysis.

It is therefore desirable to capture a set of images exposed at different delays with respect to the illumination but in which the images are captured with as little variation in the object conditions as possible from one image to the next. It has been proposed that a number of image intensifiers (as examples of capture devices), each modulated at a different phase, be used to capture simultaneously a set of images. This leads to the difficulty of balancing different photocathodes in order to make accurate differential measurements. It is also more expensive due to the use of multiple gated image intensifiers. Furthermore, it requires an optical splitter to share fluorescence light between each of the intensifiers. Others have suggested splitting and delaying different image channels onto a single detector. However, this requires complicated optics and reduces the field of view, despite avoiding the significant cost of multiple gated image intensifiers. The currently adopted approach is to use a single modulated image intensifier and an electronic camera to capture a succession of images at various delays, each captured one after another. Even in the presence of a very bright signal and with the facility of very rapid phase switching, the shortest time in which such a system can capture a set of N images with different phases is given by the electronic camera's readout time multiplied by N. Typically, this readout time is of the order of tens of milliseconds, leading to an acquisition time that is a significant fraction of a second. If the target that is being imaged moves during this time, then the set of images obtained will not be aligned, making any subsequent image analysis more difficult and/or less useful.

It will be appreciated that, for other applications, the set of images may be formed by varying capture conditions other than the phase of the illumination source and the capture device. For example, it is possible to capture sets of images by varying the polarisation of the light that is to be captured and/or the range of frequencies (wavelengths) that are to be captured.

According to one aspect of the present invention, there is provided an imaging apparatus comprising:

a capture device operable to capture a sequence of component images of a target to be imaged;

and an image generator operable to generate a plurality of output images;

wherein the image generator is operable to generate respective output images from corresponding subsets of two or more component images, and the capture device is operable to capture the component images such that the component images of one subset are interleaved with the component images of other subsets in the sequence of component images.

Embodiments of the invention capture a sequence of component images and then form a set of output images as a combination (or integration) of these component images. The component images used to generate one output image are interleaved with the component images used to generate the other output images. Each output image is therefore captured over substantially the same capture period, as opposed to capturing each output image one after the other. Therefore, if the target to be imaged is not stationary, the motion effects are substantially the same for all of the output images, i.e. the component images remain substantially aligned. This has the advantage of improving the quality of any subsequent analysis that is performed based upon the output images. In situations where the sample exhibits photobleaching or fluctuations in illumination intensity, such variations are experienced more equally by the interleaved component images and this reduces the deleterious impact of such variations on subsequent analysis.

Embodiments of the invention may generate output images from respective subsets of component images interleaved according to any interleaving pattern. However, in preferred embodiments of the invention, if there are N output images, then, for each output image the corresponding subset of component images comprises component images spaced N apart in the sequence of component images. Such an interleaving pattern helps to ensure that any motion of the target being imaged is likely to be more evenly distributed across the output images. If a less regular interleaving pattern is used then it is likely that more pronounced motion artefacts will be present in the output images, which may potentially reduce the value/accuracy of the subsequent analysis.

Whilst embodiments of the invention may provide a variety of conditions in which images of the target may be captured, preferred embodiments of the invention comprise a light pulse generator operable to illuminate the target to be imaged with one or more pulses of light; and a light modulator operable to modulate light incident upon the capture device such that the capture device captures light at a predetermined delay time following a pulse of light, different subsets of component images having different predetermined delay times. The combined usage of a light pulse generator and a light modulator enables the imaging apparatus to generate output images that have different phases of the source illumination and the light detector. This is particularly useful in, for example, time-resolved imaging, such as FLIM.

Whilst embodiments of the invention may generate output images from light from a single pulse of the light pulse generator, preferred embodiments of the invention capture component images over a time period spanning a predetermined number of light pulses, the predetermined number of light pulses being dependent upon the subset to which the component image being captured belongs. In many applications, the intensity of the light received by the imaging apparatus from a single light pulse will be insufficient to generate a component image of sufficient resolution. By capturing a component image over the duration of multiple light pulses, component images of higher quality can be achieved.

As the intensity of light incident upon the imaging apparatus may vary over time following a pulse from the light pulse generator, component images (and thus output images) captured at different phases may have dissimilar signal levels. Therefore, in preferred embodiments of the invention the predetermined number of light pulses corresponding to a subset of component images is dependent upon the corresponding predetermined delay time. Furthermore, as the intensity of light incident upon the imaging apparatus is expected to decrease in time following a pulse of light, in preferred embodiments of the invention, subsets of component images with larger corresponding predetermined delay times have larger corresponding predetermined numbers of light pulses. Such dependence of the predetermined number of light pulses on the predetermined delay time enables component images for different phases to be captured over different capture periods, thereby enabling the signal levels across the component images for different phases to be substantially balanced.

Furthermore, preferred embodiments of the invention comprise a timing controller operable to synchronise the capture device and the light pulse generator in accordance with the predetermined delay times and the predetermined numbers of light pulses. Such a timing controller ensures that phases of the output images generated by the imaging apparatus are more precise, as the light pulses and the image captures are synchronised and controlled by the timing controller.

Whilst embodiments of the invention may make use of any predetermined delay times, preferred embodiments of the invention comprise a delay time input device operable to receive input from a user and to set the predetermined delay time for one or more of the subsets of component images in accordance with the input from the user. As such, the imaging apparatus becomes more flexible and useful by allowing more specific phases to be captured.

Furthermore, preferred embodiments of the invention comprise a pulse number input device operable to receive input from a user and to set the predetermined number of light pulses for one or more of the subsets of component images in accordance with the input from the user. As such, the imaging apparatus becomes more flexible and useful by allowing more specific numbers of pulses (i.e. capture periods) to be specified.

Whilst embodiments of the invention may generate output images in many different ways, in preferred embodiments of the invention the capture device comprises a plurality of image stores and the image generator generates each output image in a corresponding image store, the capture device being operable to switch between the image stores in dependence upon the subset to which the component image being captured belongs. Such preferred embodiments provide for faster image captures, as the component images do not need to be read out of the imaging apparatus for storage elsewhere (since the imaging apparatus has multiple stores, one for each output image, to which the component images contribute).

Embodiments of the invention may realise the image stores in variety of ways. However, in preferred embodiments of the invention, the image stores correspond to different cameras, this making for a relatively simple imaging apparatus construction design. In alternative preferred embodiments, the capture device comprises a charged coupled device (CCD) array and the image stores correspond to different pixel areas of an image to be read out from the imaging apparatus, preferably interleaved rows or columns of pixels of the image to be read out from the imaging apparatus. This has the advantage of using a single CCD capture device and allows the use of standard techniques for reading out the multiple image stores simultaneously (in the form of one image read out from the camera). Having the images stored as interleaved rows or columns of pixels allows for a more simple design.

Whilst embodiments of the invention may be arranged to generate a single set of output images, preferred embodiments of the invention are operable to generate one or more sequences of output images and to output the one or more sequences of output images as one or more video sequences. Such preferred embodiments may provide real-time FLIM video for example, which may improve the analysis of the target being imaged.

Furthermore, preferred embodiments of the invention comprise an image analyser operable to compare at least two of the output images and to determine, from the comparison, properties of the imaged target, thereby allowing analysis such as time-resolved, spectrally-resolved and polarisation-resolved analysis to be performed.

According to another aspect of the present invention, there is provided a method of imaging comprising the steps of:

capturing a sequence of component images of a target to be imaged; and

generating a plurality of output images from corresponding subsets of two or more component images;

wherein the component images are captured such that the component images of one subset are interleaved with the component images of other subsets in the sequence of component images.

Embodiments of the invention will now be described with reference to the accompanying drawings in which:

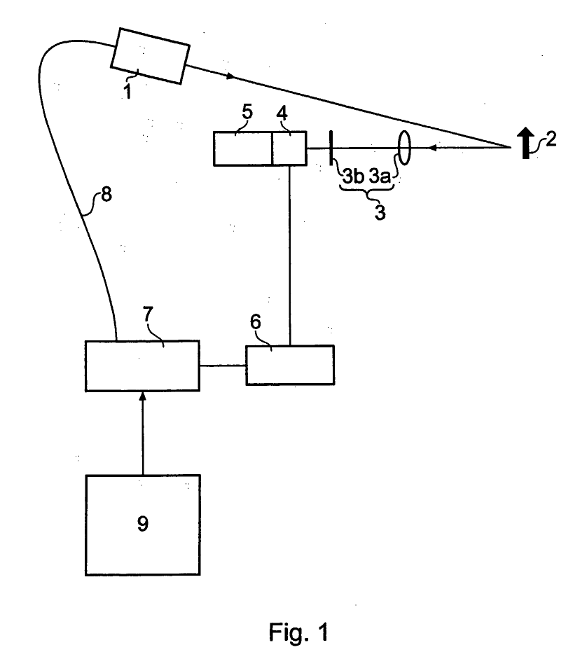

FIG. 1 schematically illustrates an imaging system;

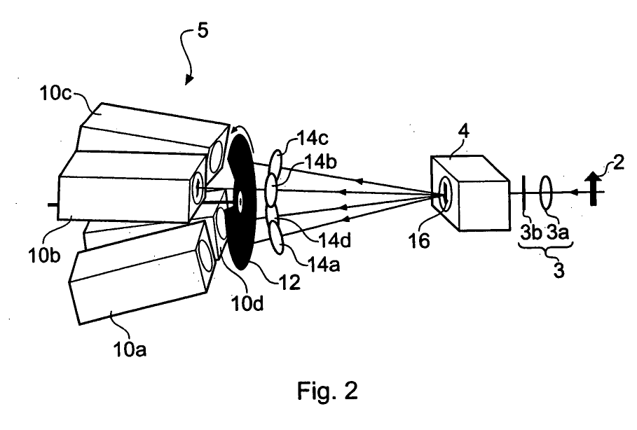

FIG. 2 schematically illustrates an example of a cyclic integrating electronic camera;

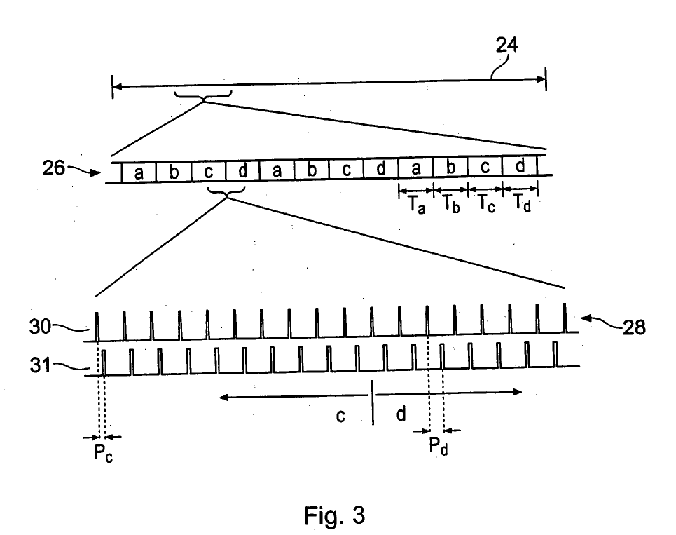

FIG. 3 schematically illustrates an acquisition period; and

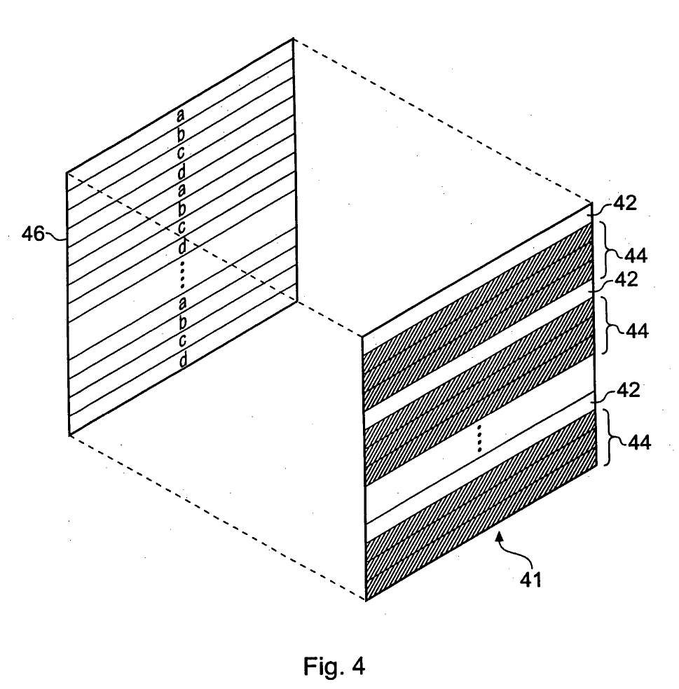

FIG. 4 schematically illustrates an example CCD camera with multiple image stores.

An embodiment of the invention will be described with reference to FLIM. However, it will be appreciated that embodiments of the invention may also be applied to other areas of image analysis, examples of which will be described later.

FIG. 1 schematically illustrates an imaging system. A pulsed light source 1 illuminates a target object 2 that is to be imaged. The target object 2 is an object that is suitable for FLIM (for example, a fluorophore, not shown, may have been introduced into the target object 2). Input optics 3 comprises a lens 3a and a filter 3b. The lens 3a forms an image of the target object 2 and the filter 3b rejects the scattered original illumination from the pulsed light source 1 but passes the fluorescence light (it being at a different wavelength). A modulated light detector 4, which in this embodiment is a modulated image intensifier, detects the image formed by the fluorescence light passing through the input optics 3. The modulation of the modulated light detector 4 will be described in more detail later. An electronic camera 5 integrates the image detected by the modulated light detector 4 for a defined period of time, which may be span several pulses of illumination from the pulsed light source 1. The electronic camera 5 includes the means to integrate the received light signal into one of several image stores. As such, a different destination image store may be used according to the current modulation pattern of the modulated light detector 4. This will be described in more detail later. The modulated light detector 4 is driven by drive electronics 6 which are triggered by a programmable trigger sequencer 7. A synchronisation signal 8 synchronises the pulsed light source 1 and the trigger sequencer 7. In one embodiment, the pulsed light source 1 generates the synchronisation signal 8 and the trigger sequence 7 is responsive to the synchronisation signal 8. In an alternative embodiment, the trigger sequencer 7 generates the synchronisation signal 8 and the pulsed light source 1 is responsive to the synchronisation signal 8. In yet a further embodiment, the synchronisation signal 8 is generated by an external means (not shown) and both the pulsed light source 1 and the trigger sequence 7 are responsive to the synchronisation signal 8. In this way, different phases of the pulsed light source 1 and the modulated light detector 4 can be achieved. The trigger sequence 7 is programmed by a host computer 9.

FIG. 2 schematically illustrates an example of a cyclic integrating electronic camera 5, in which there are multiple stores between which the image detected by the modulated light detector 4 may be cycled. Four conventional electronic cameras (or image stores) 10a, 10b, 10c and 10d have image planes that are shuttered by a rotating shutter wheel 12. Four coupling lenses 14a, 14b, 14c and 14d provide the respective electronic cameras 10a, 10b, 10c and 10d with a similar view of the phosphor 16 on the rear of the modulated light detector (image intensifier) 4. In this way, one of the electronic cameras 10a, 10b, 10c or 10d acts as the currently active image store and is able to integrate the light that it receives for a given period of time, as will be described in more detail below.

Whilst four electronic cameras 10a, 10b, 10c and 10d are shown making up the images stores of the electronic camera 5, it will be appreciated that more or fewer may be used in different embodiments depending on the number of images that need to be acquired.

At the start of an acquisition period, a modulation pattern is established for the modulated light detector 4 to sample light from the target object 2 at a particular phase Pa with respect to the pulsed light source 1. The first image store 10a is made active by appropriate rotation of the shutter wheel 12. The light signal from the modulated light detector 4 is integrated into this image store for a period of time Tₐ, which may be longer than the illumination pulse spacing so that several pulses of light from the pulsed light source 1 occur during Tₐ and contribute to the integration of the image in the image store 10a. After the period of time Tₐ, the modulation pattern of the modulated light source 4 is changed so that it samples a new phase P_{b}, and the next image store 10b is made active by appropriate rotation of the shutter wheel 12. The light signal from the modulated light detector 4 is integrated into this image store for a period of time T_{b}. The process continues in this way through the remaining image stores 10c and 10d with corresponding phases P_{c} and P_{d} and integration periods of time T_{c} and T_{d}. In this way, each of the image stores 10a, 10b, 10c and 10d only receives light according to its corresponding phase. The cycle time, Tcycle=T_{c}+T_{c}+T_{c}+T_{c}, is less that the acquisition period in order that, during the course of the acquisition period, the cycling around the image stores is repeated a number of times such that the integrated image in each of the said stores is made up of the sum of a number of interleaved sub images.

The advantage of this cyclic integration is that the integration periods for each of the images are effectively the same since each image is composed of a number of time slices spread over the complete acquisition period. This renders measurements based of differences between images captured at different phases insensitive to changes that occur during the acquisition (such as movement of the target 2 being imaged). So long as these changes do not occur on a timescale comparable to the integration cycle time, Tcycle, there will not be a significant differential effect on the captured images. The cycle time may be less than the time taken to capture a succession of several images in the more conventional serial fashion (i.e. reading out from a single electronic camera after capturing an image at each phase), due to the inherent delay of having to read out each captured image in the conventional system. The cyclic integration therefore allows a set of meaningful images to be captured in situations in which changes occur on timescales that are much shorter than the electronic camera readout time.

The intensity of the fluorescence light decays approximately exponentially after a pulse of light from the pulsed light source 1. The intensity of light received by each of the image stores 10a, 10b, 10c and 10d will therefore vary in dependence upon the corresponding phases that are being used. As such, in preferred embodiments, the integration periods Tₐ, T_{b}, T_{c} and T_{d} may be varied in order to achieve a substantially similar signal level in each of the image stores 10a, 10b, 10c and 10d. Preferably, the integration period is increased as the phase between the pulsed light source 1 and the modulated light detector 4 increases.

The choice of values for the phases Pₐ, P_{b}, P_{c} and P_{d} and integration period Tₐ, T_{b}, T_{c} and T_{d} are input by an operator using the host computer 9. The operator may be presented with a set of predetermined possibilities for the values; alternatively, the operator may enter the desired values directly. The trigger sequencer 7 controls the modulation pattern of the modulated light detector 4 and determines which image store 10a, 10b, 10c or 10d is currently active (via the drive electronics 6) in dependence upon the phases and integration periods that it receives from the host computer 9 and the synchronisation signal 8.

FIG. 3 schematically illustrates an acquisition period 24 that includes several cycles of the cyclic multiple store electronic camera 5. Each cycle involves sequentially using the image stores 10a, 10b, 10c and 10d. The acquisition period 24 is subdivided into integration sections a, b, c and d that correspond to the image stores 10a, 10b, 10c and 10d respectively. Each of the integration sections a, b, c and d last for a corresponding integration period Tₐ, T_{b}, T_{c} and T_{d}. A part 26 of the acquisition period 24 shows a number of the cycles between the image stores 10a, 10b, 10c and 10d of the electronic camera 5. A transition from using the image store 10c to using the image store 10d is shown in a part 28, which indicates the light pulse frequency 30 of the pulsed light source 1 and the modulation pattern 31 used by the modulated light detector 4. In this embodiment, the modulation pattern 31 is a simple train of square gates at a fixed delay after a corresponding pulse of illumination, although the skilled man will appreciate that other modulation patterns 31 are possible. The phases P_{c} and P_{d} are shown as the time difference between the pulsed light source 1 producing a pulse of illumination and the modulated light detector 4 being modulated so as to detect light. As can be seen, each of the image stores 10a, 10b, 10c and 10d collects light detected at a particular phase setting and the integration periods for each of them are substantially overlapping.

It will be appreciated that there are many other means by which the function of the cyclic integrating camera 5 shown in FIG. 2 may be realised. For example, a single electronic camera may be used to replace the four cameras 10a, 10b, 10c and 10d and its active area may be divided into several smaller areas, each forming one of the image stores to be cycled. Other means might be used to select an active store area, such as a dynamic deflector, LCD shutter or multiple aperture wheels.

A preferred method for realising a cycling integrating camera 5 is to use an electronic camera in which a charged coupled device (CCD) sensor captures an image. FIG. 4 schematically illustrates an example CCD camera 40 with multiple image stores. The CCD camera 40 is a traditional CCD camera with a CCD array 41 that has been modified such that light is masked from all but every forth row of pixels. Rows of pixels 42 have not been masked and are therefore sensitive to incident light, whereas the remaining rows of pixels 44 have been masked off. Preferably, the rows of pixels 42 are larger than the rows of pixels 44 so that the light collection efficiency of the CCD camera 40 may be increased. There are four image stores a, b, c and d, each of which consist of every forth line in the image array 46, starting at different row offsets. The CCD clocking is arranged such that the charge for each pixel of the rows 42 is directed to the appropriate image store a, b, c or d according to which one is currently active. After the complete acquisition period, an image read out from the CCD camera 40 would be performed in the conventional way, with the set of four captured images appearing as interlaced lines in the image read out.

Capture devices with multiple image stores have been proposed already. It should be noted that embodiments of the invention are distinct from the so-called “framing operation” of such image capture devices in which a succession of images are captured for the purpose of providing a “movie” of a changing scene. In framing operation, only a single exposure is integrated into each image store, whereas in embodiments of the invention, the light integrated into a particular image store is composed of a plurality of exposures.

The use of an electronically switched multi-frame camera (such as the CCD camera 40) allows the cycle time between the image stores to be significantly shorter than with a mechanically switched system. This allows more precise overlapping of the integration periods for the various phases to be captured, and hence a better balance from frame to frame. Moreover, no image splitting is required.

The maximum rate of acquisitions is set by the time to read out the electronic camera 5. However, the shortest time in which a set of images may be captured is given by the minimum time taken to cycle from one image store to the next multiplied by the number of image stores, assuming that there is enough light available for capturing the desired images. The minimum store to store switching time is the greater of the phosphor persistence time of the image intensifier 4 and the time taken to switch between the stores of the cyclic integrating camera 5, be this either mechanical or electronic.

Preferred embodiments of the invention therefore make use of a fast decay phosphor in the image intensifier 4, as this helps to decrease the minimum store switching time. A typical fast decay phosphor such as the P46 type allows store to store switching in about 5 microseconds, assuming that the cycling integrating camera 5 is switched electronically and switched no slower than this. With four image stores, a set of four images could be captured in 20 microseconds. However, due to relatively low signal levels, the acquisition period would be a few milliseconds after tens of image store switching cycles.

Embodiments of the invention allow sets of images to be captured within a period of, say, 20 milliseconds. These images can then be used for form a single frame in a video sequence. As such, embodiments of the invention can be arranged to produce a real-time video sequence from the captured images. Alternatively, multiple real-time video sequences may be produced by combining the various output images in different ways.

Whilst the invention has been described with reference to FLIM, it will be appreciated that embodiments of the invention may also be applied to the study of other time dependencies, such as time-resolved imaging through turbid media (for example for optical tomography or transillumination of biological tissue, in which a series of images must be captured with different phases). Embodiments of the invention may be applied to LIDAR (or light-radar) in which the transit time of pulsed illumination can be used to determine the range of objects in a scene. Embodiments of the invention allow multiple images to be captured, effectively simultaneously and on the same optical axis, but with different range gate settings. This reduces motion blurring and removes distortion due to parallax (caused by different viewing angles), allowing a 3D image to be captured with a single detector at video rates.

In so far as the embodiments of the invention described above are implemented, at least in part, using software-controlled data processing apparatus, it will be appreciated that a computer program providing such software control and a transmission, storage or other medium by which such a computer program is provided are envisaged as aspects of the present invention.

1. An imaging apparatus comprising:
a capture device operable to capture a sequence of component images of a target to be imaged; and
an image generator operable to generate a plurality of output images;
wherein the image generator is operable to generate respective output images from corresponding subsets of two or more component images, and the capture device is operable to capture the component images such that the component images of one subset are interleaved with the component images of other subsets in the sequence of component images.

2. An imaging apparatus as claimed in claim 1 wherein there are N output images and, for each output image, the corresponding subset of component images comprises component images spaced N apart in the sequence of component images.

3. An imaging apparatus as claimed claim 1 further comprising:
a light pulse generator operable to illuminate the target to be imaged with one or more pulses of light; and
a light modulator operable to modulate light incident upon the capture device such that the capture device captures light at a predetermined delay time following a pulse of light, different subsets of component images having different predetermined delay times.

4. An imaging apparatus as claimed in claim 3 in which the capture device is operable to capture component images over a time period spanning a predetermined number of light pulses, the predetermined number of light pulses being dependent upon the subset to which the component image being captured belongs.

5. An imaging apparatus as claimed in claim 4 in which the predetermined number of light pulses corresponding to a subset of component images is dependent upon the corresponding predetermined delay time.

6. An imaging apparatus as claimed in claim 5 in which subsets of component images with larger corresponding predetermined delay times have larger corresponding predetermined numbers of light pulses.

7. An imaging apparatus as claimed in claim 4 further comprising: a timing controller operable to synchronise the capture device and the light pulse generator in accordance with the predetermined delay times and predetermined numbers of light pulses.

8. An imaging apparatus as claimed in claim 3 further comprising: a delay time input device operable to receive input from a user and to set the predetermined delay time for one or more of the subsets of component images in accordance with the input from the user.

9. An imaging apparatus as claimed in claim 4 further comprising: a pulse number input device operable to receive input from a user and to set the predetermined number of light pulses for one or more of the subsets of component images in accordance with the input from the user.

10. An imaging apparatus as claimed claim 1 in which the capture device comprises a plurality of image stores and the image generator is operable to generate output images in corresponding image stores, the capture device being operable to switch between the image stores in dependence upon the subset to which the component image being captured belongs.

11. An imaging apparatus as claimed in claim 10 in which the image stores correspond to different cameras.

12. An imaging apparatus as claimed in claim 10 in which the capture device i comprises a CCD array and the image stores correspond to different pixel areas of an image to be read out from the imaging apparatus.

13. An imaging apparatus as claimed in claim 12 in which the different pixel areas comprise interleaved rows or columns of pixels of the image to be read out from the I imaging apparatus.

14. An imaging apparatus as claimed in claim 1 in which the image generator is operable to generate one or more sequences of output images and to output the one or more sequences of output images as one or more video sequences.

15. An imaging apparatus as claimed in claim 1 further comprising: an image analyser operable to compare at least two of the output images and to * determine, from the comparison, properties of the imaged target.

16. A method of imaging comprising the steps of:
capturing a sequence of component images of a target to be imaged; and
generating a plurality of output images from corresponding subsets of two or more component images;
wherein the component images are captured such that the component images of one subset are interleaved with the component images of other subsets in the sequence of component images.

17. A method of imaging as claimed in claim 16 wherein there are N output images and, for each output image, the corresponding subset of component images comprises component images spaced N apart in the sequence of component images.

18. A method of imaging as claimed in claim 16 further comprising the step of:
illuminating the target to be imaged with one or more pulses of light;
and in which the step of capturing the sequence of component images comprises capturing light at a predetermined delay time following a pulse of light, different subsets of component images having different predetermined delay times.

19. A method of imaging as claimed in claim 18 in which the component images are captured over a time period spanning a predetermined number of light pulses, the predetermined number of light pulses being dependent upon the subset to which the component image being captured belongs.

20. A method of imaging as claimed in claim 19 in which the predetermined number of light pulses corresponding to a subset of component images is dependent upon the corresponding predetermined delay time.

21. A method of imaging as claimed in claim 20 in which subsets of component images with larger corresponding predetermined delay times have larger corresponding predetermined numbers of light pulses.

22. A method of imaging as claimed in claim 19 further comprising the step of: synchronising the illumination of the target to be imaged and the capture of the sequence of component images in accordance with the predetermined delay times and the predetermined numbers of light pulses.

23. A method of imaging as claimed in claim 18 further comprising the steps of:
receiving input from a user;
and setting the predetermined delay time for one or more of the subsets of component images in accordance with the input from the user.

24. A method of imaging as claimed in claim 19 further comprising the steps of:
receiving input from a user; and
setting the predetermined number of light pulses for one or more of the subsets of component images in accordance with the input from the user.

25. A method of imaging as claimed in claim 16 further comprising the steps of:
storing the output images in a plurality of image stores; and
switching between the image stores in dependence upon the subset to which the component image being captured belongs.

26. A method of imaging as claimed in claim 25 in which the image stores correspond to different cameras.

27. A method of imaging as claimed in claim 25 in which the step of capturing the sequence of component images is performed by an imaging apparatus comprising a CCD array and the image stores correspond to different pixel areas of an image to be read out from the imaging apparatus.

28. A method of imaging as claimed in claim 27 in which the different pixel areas comprise interleaved rows or columns of pixels of the image to be read out from the imaging apparatus

29. A method of imaging as claimed in any one of claims 16 to claim 16 further comprising the steps of:
generating one or more sequences of output images; and
outputting the one or more sequences of output images as one or more video sequences.

30. A method of imaging as claimed in claim 16 further comprising the steps of:
comparing at least two of the output images; and
determining, from the comparison, properties of the imaged target.
